(19) United States
(12) Patent Application Publication
(10) Pub. No.: US 2025/0342284 A1
(43) Pub. Date: Nov. 6, 2025

(54) CERTIFICATE GENERATION ASSOCIATED WITH A MEMORY DEVICE BASED ON ACTIVE COMPONENT IDENTIFICATION INFORMATION

(71) Applicant: Micron Technology, Inc., Boise, ID (US)

(72) Inventor: Michael R. Spica, Eagle, ID (US)

(21) Appl. No.: 19/068,471

(22) Filed: Mar. 3, 2025

Related U.S. Application Data
(60) Provisional application No. 63/641,598, filed on May 2, 2024.

(51) Int. Cl. G06F 21/73; G06F 21/44; H04L 9/32

(52) U.S. Cl. CPC G06F 21/73; G06F 21/44; H04L 9/3268

(57) ABSTRACT

A processing device in a memory sub-system receives a request to generate a digital certificate associated with a memory device including a set of active components, where each active component of the set of active components is associated with an active component identifier. In response to the request, a set of active component identifiers are identified. Based on at least a portion of the set of active component identifiers, the digital certificate associated with the memory device is generated and provided to a host system, where the digital certificate is used to authenticate the memory device

### CROSS-REFERENCE TO RELATED APPLICATION

This application claims the benefit of U.S. Provisional Application No. 63/641,598, titled “Certificate Generation Associated with a Memory Device Based on Active Component Identification Information,” filed May 2, 2024, which is hereby incorporated herein by reference in its entirety.

### TECHNICAL FIELD

Embodiments of the disclosure relate generally to memory sub-systems, and more specifically, relate to a generating a certificate for authenticating a memory device of a memory sub-system based on identification information associated with one or more active components of the memory device.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing system that includes a memory sub-system in accordance with one or more embodiments of the present disclosure.

FIG. 1B is a block diagram of a memory device in communication with a memory sub-system controller of a memory sub-system, in accordance with one or more embodiments of the present disclosure.

FIG. 2 is an example host system coupled to a memory sub-system including a memory sub-system controller having a certificate generator to generate a device certificate associated with a memory device of a memory sub-system based on a set of active component identifiers, in accordance with one or more embodiments of the present disclosure.

FIG. 3 illustrates an example certificate generator to generate a device certificate associated with a memory device of a memory sub-system based on a set of active component identifiers, in accordance with one or more embodiments of the present disclosure.

FIG. 4 is a flow diagram of an example of device certificate generation process, in accordance with one or more embodiments of the present disclosure.

FIG. 5 is a block diagram of an example computer system in which embodiments of the present disclosure may operate.

### DETAILED DESCRIPTION

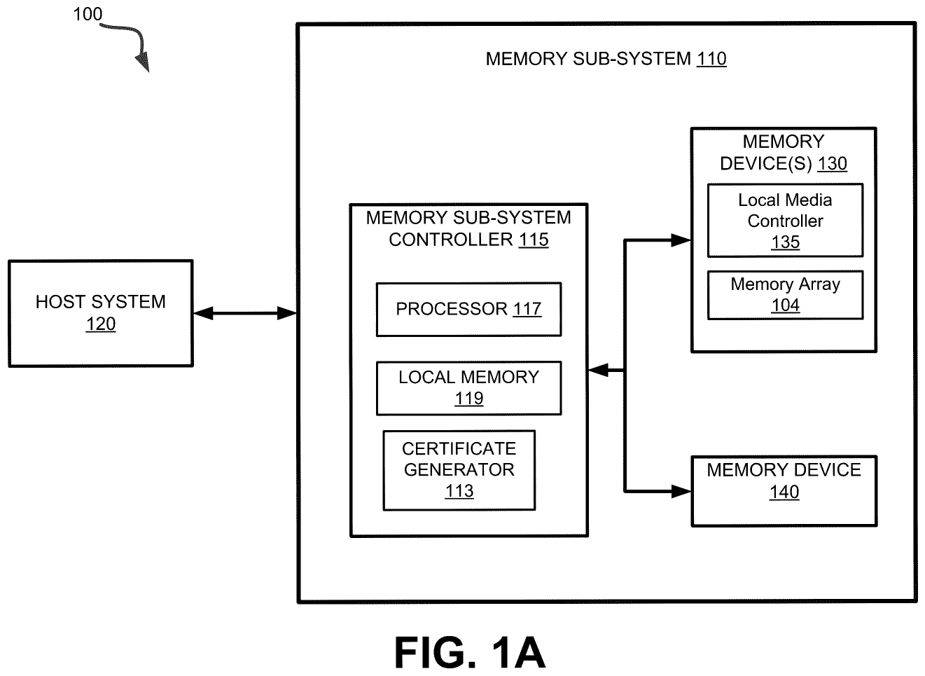

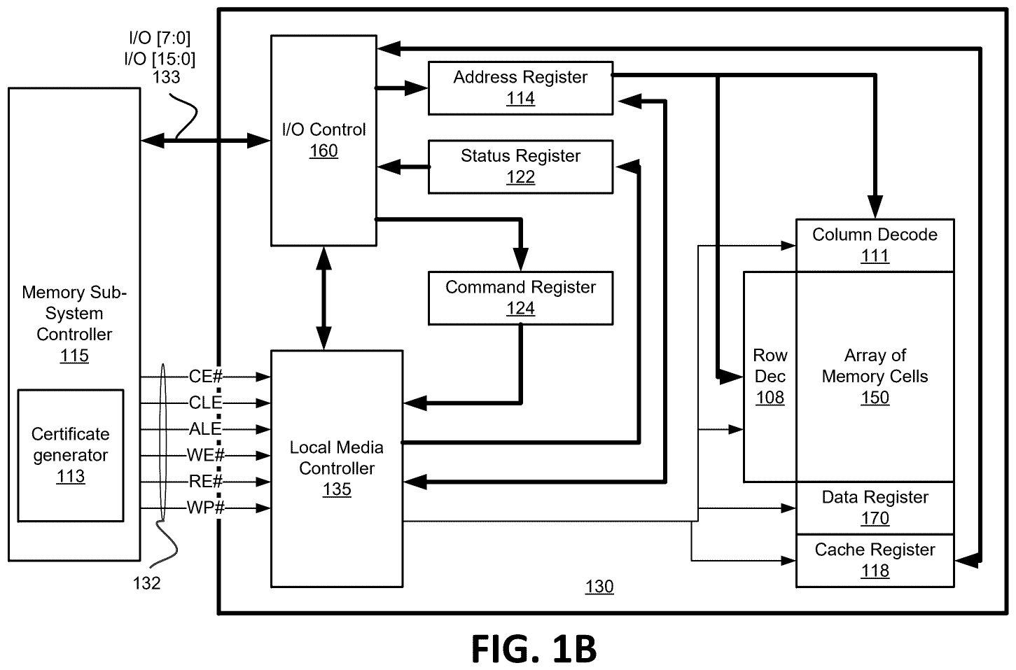

Aspects of the present disclosure are directed to generating a certificate for authenticating a memory device of a memory sub-system based at least in part on identification information associated with active components of the memory sub-system. A memory sub-system can be a storage device, a memory module, or a hybrid of a storage device and memory module. Examples of storage devices and memory modules are described below in conjunction with FIG. 1A. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. For example, NAND memory, such as 3D flash NAND memory, offers storage in the form of compact, high density configurations. A non-volatile memory device is a package of one or more memory dies, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

A memory die is also referred to as a logical unit (LUN). A LUN can contain one or more planes. A memory sub-system can use a striping scheme to treat various sets of data as units when performing data operations (e.g., write, read, erase). A LUN stripe is a collection of planes that are treated as one unit when writing, reading, or erasing data. Each plane in a LUN stripe can carry out the same operation, in parallel, on all the other planes in the LUN stripe. A block stripe is a collection of blocks that are treated as a unit. A block stripe can be a physical block stripe associated with a plane of a LUN or a logical block stripe including blocks that are mapped to the logical block stripe by processing logic. The blocks in a block stripe have the same identifier(s) that associates the blocks to the block stripe (e.g., block number, block stripe index, etc.).

Some memory devices, such as three-dimensional (3D) cross-point devices, can include multiple decks represented by respective two-dimensional (2D) arrays of memory cells electronically addressable by a vertical access line(s) (e.g., wordline(s)). Multiple decks can be stacked within a memory device (e.g., stacked vertically). Certain memory devices are divided into multiple decks to mitigate the performance and reliability penalties. For example, as a desire for increased storage capacity in memory devices drives an expansion of block sizes, including an increase of the number of wordlines in each block, the presence of such additional wordlines, however, presents certain challenges including, for example, performance and reliability penalties attributable to various inefficiencies (e.g., associated with garbage collection or other media management operations for the increased block size). As such, a memory device could include a top (or “upper”) deck and a bottom (or “lower”) deck, each including a respective set of wordlines from the memory device. The separate decks are individually accessible, such that a memory access operation (i.e., a program, read, or erase operation) could be performed on one deck without impacting memory cells of the other deck.

For integrity and security purposes, a host system that is operatively coupled to a third-party unit may want to authenticate that unit (e.g., a memory device of a memory sub-system). For example, in certain systems, in order to authenticate a third-party memory device coupled to a host system, control logic can generate an authentication certificate based on basic information associated with the unit, such as a hashed combination of a part number of the memory device and an associated firmware version identifier. For example, when the memory device is coupled to the host system, an authentication check on the memory device can be initiated by generating a certificate based on the part number and firmware version number. The generated certificate can be provided to the host system which can use a certificate authority to check the validity of the information stored in the certificate to determine whether the memory device is authenticated.

However, use of a certificate based on a hardware model number and firmware version number can result in the generation of a certificate that is the same for multiple different memory devices, and not unique to a particular memory device. Furthermore, this approach to authenticating is ineffective in detecting occurrences of post-manufacturing tampering or modifying of one or more components or sub-components of a physical memory device. In such cases, the certificate that is based on the firmware version and hardware serial number associated with the complete physical system (as manufactured) does not enable the detection of instances when one or more sub-components of the physical system have been tampered following entry of the system into the chain of commerce. Accordingly, memory devices which have been improperly modified still pass authentication measures since the certificate based on the hardware serial number and the firmware version provide no mechanism to detect those modifications.

Aspects of the present disclosure address the above and other deficiencies by implementing a process to enable the authentication of a memory device having a set of active components (i.e., sub-components of the memory device). The process includes the generating of an authentication certificate associated with the memory device which is based at least in part on one or more identifiers associated with respective active components of the memory device. Example active components include one or more microcontrollers, special purpose logic circuitry (e.g., a field programmable gate array (FPGA), one or more an application specific integrated circuit (ASIC), one or more memory devices (e.g., read-only memory (ROM), flash memory, dynamic random access memory (DRAM) such as synchronous DRAM (SDRAM) or Rambus DRAM (RDRAM), etc.), a static memory (e.g., flash memory, static random access memory (SRAM), etc.), one or more non-volatile memory devices (e.g., NAND memory devices or NAND chips), one or more printed circuit boards (PCBs), one or more media card controllers, etc.

According to embodiments, each of the active components of the memory sub-system is associated with a unique identifier (herein referred to as an “active component identifier”). According to embodiments, a unique authentication certificate is generated for the memory sub-system based on a set of one or more active component identifiers corresponding to one or more components of the memory sub-system. Use of one or more active component identifiers in the generation of the authentication certificate enables each memory sub-system to be uniquely authenticated based on identifying information associated with one or more of the constituent active components or parts. This approach avoids the generation of certificates that broadly characterize more than one memory sub-system by creating a more robust certificate built on a larger set of identifying information that is unique to the particular memory sub-system. Advantageously, the certificate generation approach described herein establishes the provenance of a specific unit or system manufactured or constructed by an associated source manufacturer to reduce the risks associated with counterfeit construction and post-manufacturing tampering.

FIG. 1A illustrates an example computing system 100 that includes a memory sub-system 110 in accordance with some embodiments of the present disclosure. The memory sub-system 110 can include media, such as one or more ultra-high endurance storage class memory devices (e.g., memory device 140), one or more non-volatile memory devices (e.g., one or more memory device(s) 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1A illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, compute express link (CXL) interface). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a CXL interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. For example, the ultra-high endurance storage class memory device 140 can include any of a number of different types of memory media or “cells” that are non-volatile and offer lower program/read latency than 3D NAND type flash memory, including both SLC memory and QLC memory. In addition, the ultra-high endurance storage class memory device 140 can have higher endurance (i.e., can tolerate a greater number of program/erase cycles) than memory device 130. Some examples of ultra-high endurance storage class memory include hybrid random access memory (HRAM), three-dimensional cross-point (“3D cross-point”) memory, or others.

Some examples of non-volatile memory devices (e.g., memory device(s) 130) include not-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2DNAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), or penta-level cells (PLCs) can store multiple bits per cell. In some embodiments, each of the memory devices 130 can include one or more arrays of memory cells such as SLCs, MLCs, TLCs, QLCs, PLCs, or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control or processing logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, the memory sub-system controller 115 includes a certificate generator 113 that can implement a process to generate an authentication certificate associated with the memory sub-system 110 based on authentication information corresponding to one or more active components of the memory sub-system 110. The active components of the memory sub-system 110 can include any component of the one or more memory devices 130, 140 of the memory sub-system 110. In an embodiment, the certificate generator 113 generates a unique certificate based at least in part on a set of one or more unique identifiers corresponding to respective active components of the one or more memory devices 130, 140 of the memory sub-system 110. According to embodiments, the certificate generator 113 identifies a set of active component identifiers and executes a certificate generation process or algorithm to produce a corresponding certificate. The certificate generator 113 provides the generated certificate to the host system 120, which in turn uses the certificate to authenticate one or more portions of the memory sub-system 110. In an embodiment, the host system 120 can employ a signing authority to authenticate the one or more portions of the memory sub-system 110 using the generated certificate.

Advantageously, generating the certificate by executing a certificate generation process or algorithm using at least one or more unique identifiers associated with active components (or sub-components) of the memory sub-system 110 provides for a robust certificate that uniquely identifies the memory sub-system 110 and reduces risks associated with post-manufacturing tampering with the memory sub-system 110. For example, the generated certificate can be used to reject authentication of a memory sub-system 110 having one or more active components (e.g., an ASIC, a PCB, a NAND, a DRAM, etc.) that have been replaced, modified, or otherwise tampered at some point in the lifecycle of the memory sub-system 110. Further details with regards to the operations of certificate generator 113 are described below.

FIG. 1B is a simplified block diagram of a first apparatus, in the form of a memory device 130, in communication with a second apparatus, in the form of a memory sub-system controller 115 of a memory sub-system (e.g., memory sub-system 110 of FIG. 1A), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device. In one embodiment, the memory sub-system controller 115 includes certificate generator 113, which can implement the wordline group-based identification of a first portion (i.e., a good portion) of a block during a programming operation, while skipping the programming of a second portion (i.e., a bad portion) of the block, as described herein.

Memory device 130 includes an array of memory cells 150 logically arranged in rows and columns. Memory cells of a logical row are typically connected to the same access line (e.g., a wordline) while memory cells of a logical column are typically selectively connected to the same data line (e.g., a bitline). A single access line may be associated with more than one logical row of memory cells and a single data line may be associated with more than one logical column. Memory cells (not shown in FIG. 1B) of at least a portion of array of memory cells 250 are capable of being programmed to one of at least two target data states.

Row decode circuitry 108 and column decode circuitry 111 are provided to decode address signals. Address signals are received and decoded to access the array of memory cells 150. Memory device 130 also includes input/output (I/O) control circuitry 160 to manage input of commands, addresses and data to the memory device 130 as well as output of data and status information from the memory device 130. An address register 114 is in communication with I/O control circuitry 160 and row decode circuitry 108 and column decode circuitry 111 to latch the address signals prior to decoding. A command register 124 is in communication with I/O control circuitry 112 and local media controller 135 to latch incoming commands.

A controller (e.g., the local media controller 135 internal to the memory device 130) controls access to the array of memory cells 150 in response to the commands and generates status information for the external memory sub-system controller 115, i.e., the local media controller 135 is configured to perform access operations (e.g., read operations, programming operations and/or erase operations) on the array of memory cells 150. The local media controller 135 is in communication with row decode circuitry 108 and column decode circuitry 111 to control the row decode circuitry 108 and column decode circuitry 111 in response to the addresses. In one embodiment, local media controller 135 includes program manager 134, which can implement the wordline group-based identification of a first portion (i.e., a good portion) of a block during a programming operation, while skipping the programming of a second portion (i.e., a bad portion) of the block., as described herein.

The local media controller 135 is also in communication with a cache register 118. Cache register 118 latches data, either incoming or outgoing, as directed by the local media controller 135 to temporarily store data while the array of memory cells 150 is busy writing or reading, respectively, other data. During a program operation (e.g., write operation), data may be passed from the cache register 118 to the data register 121 for transfer to the array of memory cells 150; then new data may be latched in the cache register 118 from the I/O control circuitry 160. During a read operation, data may be passed from the cache register 118 to the I/O control circuitry 160 for output to the memory sub-system controller 115; then new data may be passed from the data register 121 to the cache register 118. The cache register 118 and/or the data register 121 may form (e.g., may form a portion of) a page buffer of the memory device 130. A page buffer may further include sensing devices (not shown in FIG. 1B) to sense a data state of a memory cell of the array of memory cells 150, e.g., by sensing a state of a data line connected to that memory cell. A status register 122 may be in communication with I/O control circuitry 160 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE #, a command latch enable signal CLE, an address latch enable signal ALE, a write enable signal WE #, a read enable signal RE #, and a write protect signal WP #. Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 133 and outputs data to the memory sub-system controller 115 over I/O bus 133.

For example, the commands may be received over input/output (I/O) pins [7:0] of I/O bus 133 at I/O control circuitry 112 and may then be written into command register 124. The addresses may be received over input/output (I/O) pins [7:0] of I/O bus 133 at I/O control circuitry 160 and may then be written into address register 114. The data may be received over input/output (I/O) pins [7:0] for an 8-bit device or input/output (I/O) pins [15:0] for a 16-bit device at I/O control circuitry 112 and then may be written into cache register 118. The data may be subsequently written into data register 170 for programming the array of memory cells 150.

In an embodiment, cache register 118 may be omitted, and the data may be written directly into data register 170. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

It will be appreciated by those skilled in the art that additional circuitry and signals can be provided, and that the memory device 130 of FIG. 1B has been simplified. It should be recognized that the functionality of the various block components described with reference to FIG. 1B may not necessarily be segregated to distinct components or component portions of an integrated circuit device. For example, a single component or component portion of an integrated circuit device could be adapted to perform the functionality of more than one block component of FIG. 1B. Alternatively, one or more components or component portions of an integrated circuit device could be combined to perform the functionality of a single block component of FIG. 1B. Additionally, while specific I/O pins are described in accordance with popular conventions for receipt and output of the various signals, it is noted that other combinations or numbers of I/O pins (or other I/O node structures) may be used in the various embodiments.

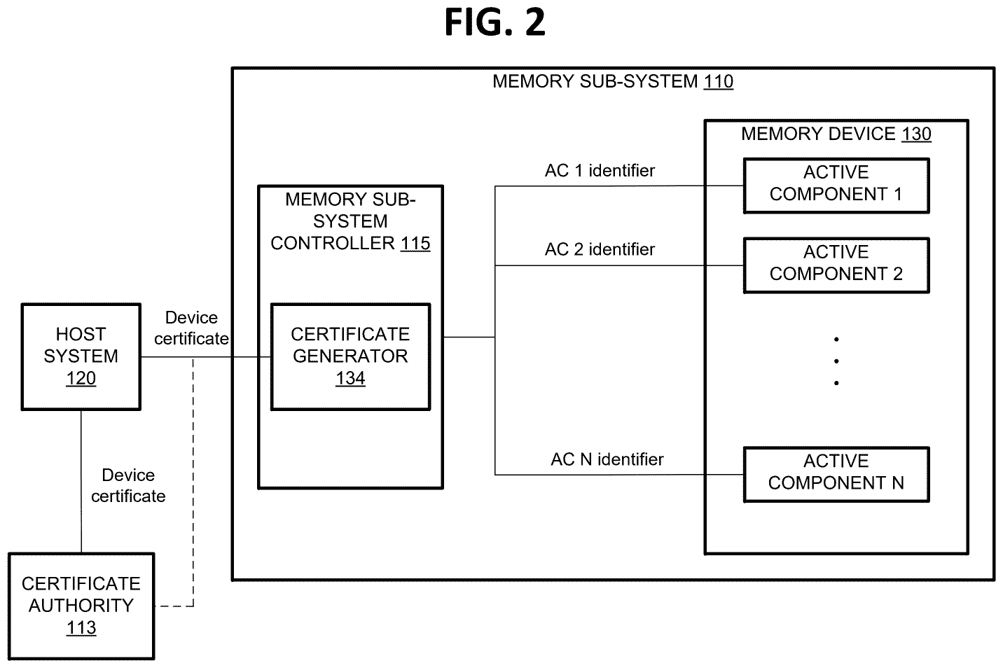

FIG. 2 is an example host system coupled to a memory sub-system 110 including a memory sub-system controller 115 having a certificate generator 134, according to embodiments of the present disclosure. In the example shown in FIG. 2, the memory sub-system 110 includes a memory device 130 having a set of active components (e.g., active component 1, active component 2 . . . active component N; where N is an integer). In an embodiment, the host system 120 may generate a request for the generation of an authentication certificate associated with the one or more portions of the memory sub-system 110. For example, in response to the coupling of the memory sub-system 110 including memory device 130 to the host system 120 (e.g., when the memory device 130 of the memory sub-system 110 is plugged into the host system) or in response to the powering up of the host system 120 coupled to the memory sub-system 110, the request for the generation of the certificate can be initiated.

In an embodiment, the memory device 130 includes a set of active components, where each active component is associated with a unique identifier (also referred to as an “active component (AC) identifier”). In response to the request, the certificate generator 134 identifies, collects, or aggregates a set of identifiers associated with at least a portion of the set of active components (e.g., active component 1, active component 2 . . . active component N) of the memory device 130. In an embodiment, the set of AC identifiers can include an individual AC identifier associated with each of the active components in the set of active components (e.g., AC 1 identifier, AC 2 identifier . . . and AC N identifier). In an embodiment, the set of AC identifiers can include a portion or subset of the set of AC identifiers (e.g., a subset of the odd-numbered active components; a subset of even-numbered active components; a subset of active components having an AC identifier including one or more designated characters or numbers, etc.).

In the example shown in FIG. 2, the certificate generator 134 collects the subset of AC identifiers including all of the available AC identifiers (e.g., AC 1 identifier, AC 2 identifier . . . and AC N identifier). In an embodiment, each AC identifier represents an electrical identifier or signature associated with a respective active component of the memory device 130. According to embodiments, the set of active components of the memory device 130 shown in FIG. 2 can include one or more of a media component (e.g., DRAM, NAND, etc.), a controller (e.g., ASIC), a read-only memory (e.g., an erasable programmable read-only memory (EPROM)), an interface (e.g., a process management interface), etc.

In an embodiment, the certificate generator 134 executes a certificate generation algorithm or process. According to embodiments, any suitable certificate generation algorithm can be executed, including, for example, a hashing algorithm, a pseudo-random number generator (e.g., a second level pseudo random number generator), a polynomial order of bits/sequence generator, a Rivest-Shamir-Adleman (RSA) algorithm, an Elliptical Curve Cryptography (ECC) algorithm, etc.

According to embodiments, the certificate generator 134 establishes an input or seed for the certificate generation algorithm. According to embodiments, the input includes at least a portion of the collected set of AC identifiers. According to embodiments, in addition to the at least the portion of the collected set of AC identifiers, the input can further include additional information, including but not limited to firmware version information, a hardware serial number associated with the memory device 130, a vendor name or identifier associated with the memory device 130, etc. For example, the certificate generator 134 can execute the certificate generation algorithm to generate a pseudo-randomized sequence of the aggregated set of AC identifiers. In an embodiment, the certificate generator 134 employs a certificate generation algorithm using the input associated with the memory device 130 such that the same certificate (e.g., a same certificate value) is generated each time the algorithm is executed to enable attestation of the memory device 130 by the host system 120.

According to embodiments, the communications between the certificate generator 134 and the memory device 130 (e.g., the collection or identification of the set of AC identifiers) can be via an ONFI interface command or a low-power double data rate (DDR) command (e.g., using read mode registers assigned a unique identifier). According to embodiments, advantageously, unique identifiers associated with multiple different types of active components (e.g., non-volatile memory devices, volatile memory devices, controllers, interfaces, etc.) can be communicated to the certificate generator 134 and used to generate a unique certificate associated with the memory device 130.

According to an embodiment, the certificate generator 134 can collect a set of unique active components identifiers associated with a memory package (e.g., a NAND memory device) including a set of multiple memory die (e.g., NAND die 1, NAND die 2 . . . NAND die 16), where each NAND die is associated with a unique active component identifier.

According to embodiments, the certificate generator 134 generates an authentication certificate associated with the memory device 130 (also referred to as a “device certificate”) based at least in part on the set of AC identifiers. Advantageously, the generated certificate represents authentication at a component-level, thereby reducing the risks associated with modifications (e.g., replacing, tampering, re-configuring, etc.) to one or more of the physical components of the memory device 130 following release of the memory device 130 into the supply chain (i.e., post manufacturing).

As illustrated in FIG. 2, the certificate generator 134 provides the generated device certificate to the host system 120. The host system 120 can provide the device certificate to a certificate authority 113 to determine if the device certificate associated with the memory device 130 is valid. In an embodiment, the certificate authority 113 can be an external (e.g., third-party) system that is communicatively coupled to the host system 120. In an embodiment, the certificate authority 113 can be local to the host system (e.g., the host system 120 stores a local copy of all valid certificates). According to an embodiment, if the host system 120 includes the certificate authority 113, the certificate generator 134 can provide the device certificate to the certificate authority 113, as denoted by the dashed line in FIG. 2.

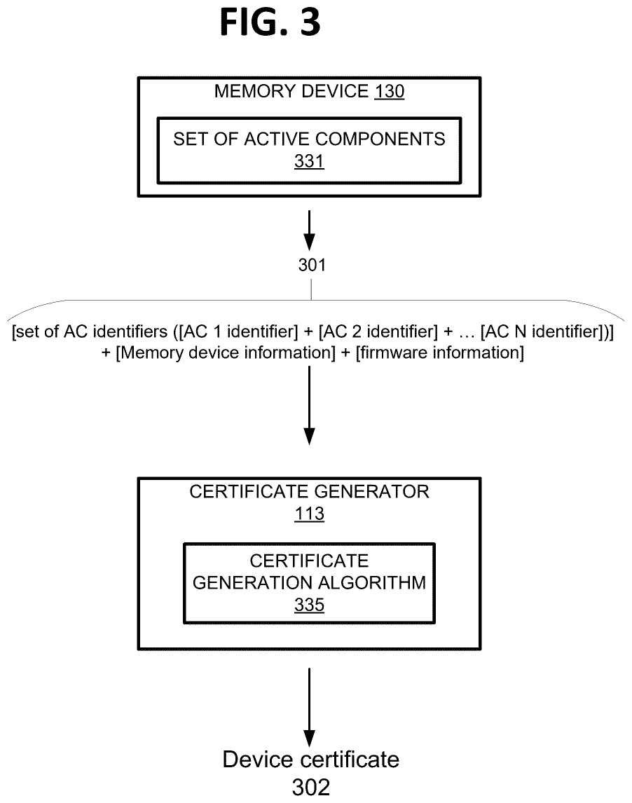

FIG. 3 illustrates an example certificate generator 113 to generate a device certificate associated with a memory device of a memory sub-system. In an embodiment, the certificate generator 113 executes a certificate generation algorithm 335 based on an input or seed value 301. According to embodiments, the seed value 301 includes a set of one or more of active component (AC) identifiers (e.g., AC 1 identifier, AC 2 identifier . . . AC N identifier). According to embodiments, the seed value 301 further includes one or more portions of additional information. In an embodiment, the additional information includes a portion of memory device information (e.g., a hardware version identifier associated with the memory device 130), a portion of firmware information (e.g., a firmware version number identifier associated with memory device 130), or both a portion of memory device information and firmware information.

As shown in FIG. 3, the certificate generator 113 executes the certificate generation algorithm 335 using the seed value 301 to generate a device certificate 302 associated with the memory device 130. Accordingly, the device certificate 302 is generated based at least in part on identifiers corresponding to constituent parts or components of the memory device 130. This approach enables the authenticity of the memory component to be validated and confirmed at a more granular level as compared to typical approaches based only on hardware version and firmware version information. For example, if the memory device 130 is tampered with at some point after manufacturing such that one or more of the active components of the memory device are replaced, the device certificate that is generated by the certificate generator 113 would not correspond with the information corresponding to the valid digital certificates maintained by the certificate authority. Accordingly, the mismatch is identified, and the device certificate is identified as being invalid. The invalidity of the device certificate associated with the memory device can be communicated to the host system to enable the host system to take a corresponding remedial action (e.g., discontinue use of the memory device, communicate the invalidity to the manufacturer of the memory device, etc.).

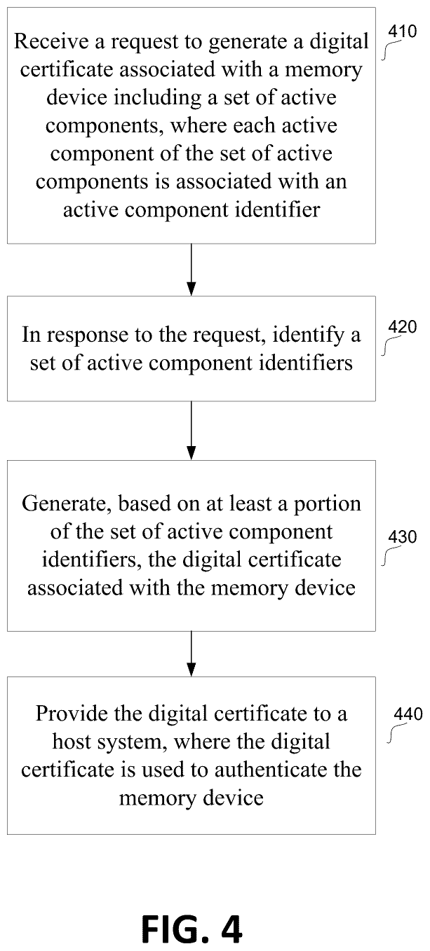

FIG. 4 is a flow diagram of an example method of generating an authentication certificate associated with a memory device of a memory sub-system coupled to a host system, in accordance with one or more embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by certificate generator 113 of FIG. 1A. FIG. 1B, FIG. 2, and FIG. 3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic (e.g., certificate generator 113) receives a request to generate a digital certificate associated with a memory device including a set of active components, where each active component of the set of active components is associated with an active component identifier. In an embodiment, the request is received by the processing logic from a host system 120 coupled to a memory sub-system including the memory device. In an embodiment, the memory device includes the set of active components including physical components such as controllers, volatile memory components (e.g., DRAM components); non-volatile memory components (e.g., NAND components), PCBs, integrated circuits (e.g., ASICs), etc. In an embodiment, each of the active components of the memory device is associated with a corresponding active component identifier (e.g., identifying information such as a manufacturer serial number that indicates a source or manufacturer of the component). In an embodiment, the request can be initiated in response to a powering up or starting up of the host system and/or the memory device.

At operation 420, in response to the request, the processing logic identifies a set of one or more active component identifiers corresponding to the set of active components of the memory device. In an embodiment, the processing logic communicates with the memory device via an ONFI command to collect the active component identifier (e.g., a unit ID associated with the respective active component) corresponding to one or more of the active components of the memory device. In an embodiment, the processing logic can transmit one or more side-band commands via a side-band channel (e.g., a slower speed channel) to the memory device to collect the set of active component identifiers. In an embodiment, the set of active component identifiers can include all or a selected portion of the total set of active components. In an embodiment, the processing logic identifies or collects additional information that may be used to generate the digital certificate. For example, the additional information can include memory device information (e.g., a serial number of the memory device), a firmware version associated with the memory device, etc.

At operation 430, the processing logic generates, based on at least a portion of the set of active component identifiers, the digital certificate associated with the memory device. In an embodiment, the processing logic can use the at least the portion of the set of active component identifiers as at least a portion of a seed value for input to a certificate generation algorithm. In an embodiment, the seed value can include the portion of the set of active component identifiers and a portion of additional information (e.g., the serial number of the memory device and firmware version information). In an embodiment, the processing logic selects one or more active component identifiers from the set of active component identifiers to use as at least a portion of the seed value for input to the certificate generation algorithm.

At operation 440, the processing logic provides the digital certificate to the host system, where the digital certificate is used to authenticate the memory device. In an embodiment, the host system can employ a certificate authority to authenticate the digital certificate. In an embodiment, the certificate authority can be a third-party system or local to the host system. In an embodiment, the certificate authority determines the validity of the digital certificate associated with the memory device by comparing the digital certificate to a set of valid digital certificates.

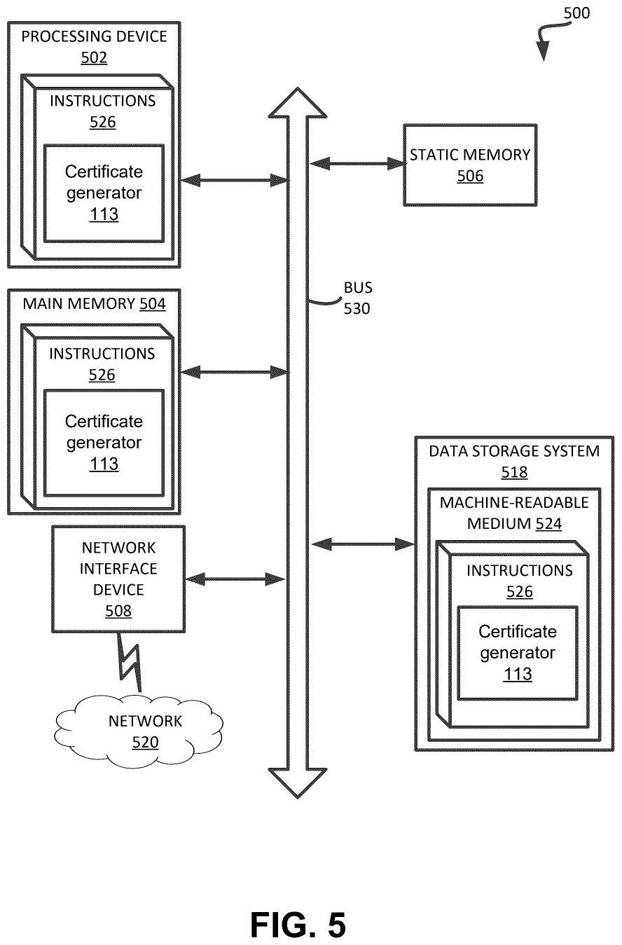

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1A and FIG. 2) that includes, is coupled to, or utilizes a memory sub-system (e.g., the memory sub-system 110 of FIG. 1A) or can be used to perform the operations of a controller (e.g., to execute an operating system to perform operations corresponding to the certificate generator 113 of FIG. 1A, FIG. 1B, FIG. 2, and FIG. 3). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1A.

In one embodiment, the instructions 526 include instructions to implement functionality corresponding to the certificate generator 113 of FIG. 1A, FIG. 1B, FIG. 2, and FIG. 3). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory sub-system comprising:
a memory device; and
a processing device, operatively coupled to the memory device, the processing device to perform operations comprising:
receiving a request to generate a digital certificate associated with a memory device comprising a set of active components, wherein each active component of the set of active components is associated with an active component identifier;
in response to the request, identifying a set of active component identifiers;
generating, based on at least a portion of the set of active component identifiers, the digital certificate associated with the memory device; and
providing the digital certificate to a host system, where the digital certificate is used to authenticate the memory device.

2. The memory sub-system of claim 1, wherein the set of active components comprises one or more of a controller circuit, a non-volatile memory component, a volatile memory component, an integrated circuit, or a printed circuit board of the memory device.

3. The memory sub-system of claim 1, wherein a seed value is established using at least a portion of the set of active component identifiers.

4. The memory sub-system of claim 3, wherein generating the digital certificate is performed using the seed value.

5. The memory sub-system of claim 3, wherein the seed value further comprises additional information.

6. The memory sub-system of claim 1, wherein the host system comprises a certificate authority system storing a set of valid digital certificates.

7. The memory sub-system of claim 6, wherein the digital certificate is compared to the set of valid digital certificates to authenticate the memory device.

8. A method comprising:
receiving a request to generate a digital certificate associated with a memory device including a set of active components, where each active component of the set of active components is associated with an active component identifier;
in response to the request, identifying a set of active component identifiers;
generating, based on at least a portion of the set of active component identifiers, the digital certificate associated with the memory device; and
providing the digital certificate to a host system, where the digital certificate is used to authenticate the memory device.

9. The method of claim 8, wherein the set of active components comprises one or more of a controller circuit, a non-volatile memory component, a volatile memory component, an integrated circuit, or a printed circuit board of the memory device.

10. The method of claim 8, wherein a seed value is established using at least a portion of the set of active component identifiers.

11. The method of claim 10, wherein generating the digital certificate is performed using the seed value.

12. The method of claim 10, wherein the seed value further comprises additional information.

13. The method of claim 8, wherein the host system comprises a certificate authority system storing a set of valid digital certificates.

14. The method of claim 13, wherein the digital certificate is compared to the set of valid digital certificates to authenticate the memory device.

15. A non-transitory computer-readable storage medium comprising instructions that, when executed by a processing device, cause the processing device to perform operations comprising:
receiving a request to generate a digital certificate associated with a memory device including a set of active components, where each active component of the set of active components is associated with an active component identifier;
in response to the request, identifying a set of active component identifiers;
generating, based on at least a portion of the set of active component identifiers, the digital certificate associated with the memory device; and
providing the digital certificate to a host system, where the digital certificate is used to authenticate the memory device.

16. The non-transitory computer-readable storage medium of claim 15, wherein the set of active components comprises one or more of a controller circuit, a non-volatile memory component, a volatile memory component, an integrated circuit, or a printed circuit board of the memory device.

17. The non-transitory computer-readable storage medium of claim 15, wherein a seed value is established using at least a portion of the set of active component identifiers.

18. The non-transitory computer-readable storage medium of claim 17, wherein generating the digital certificate is performed using the seed value.

19. The non-transitory computer-readable storage medium of claim 17, wherein the seed value further comprises additional information.

20. The non-transitory computer-readable storage medium of claim 15, wherein the host system comprises a certificate authority system storing a set of valid digital certificates; and wherein the digital certificate is compared to the set of valid digital certificates to authenticate the memory device.
